(19) United States
(12) Patent Application Publication
(10) Pub. No.: US 2003/0036979 A1
(43) Pub. Date: Feb. 20, 2003

(54) Advertisement request brokering server system, advertisement request brokering method, and advertisement request brokering program product

(75) Inventor: Mitsuhiro Tokorotani, Tokyo (JP)

Correspondence Address: SUGHRUE MION, PLLC, 2100 PENNSYLVANIA AVENUE, N.W., WASHINGTON, DC, 20037, US

(73) Assignee: NEC INFRONTIA CORPORATION

(21) Appl. No.: 10/208,775

(22) Filed: Aug. 1, 2002

(30) Foreign Application Priority Data
Aug. 15, 2001 (JP) 2001-246692

(51) Int. Cl. G06F 17/60

(52) U.S. Cl. 705/27; 705/35

(57) ABSTRACT

To provide an advertisement request brokering server, an advertisement request brokering method, and an advertisement request brokering program that facilitate making a contract between an advertiser and a store that runs an advertisement. An advertisement request brokering server for brokering an advertisement request from an advertiser between the advertiser and a store including a POS device, is connected to an advertiser terminal and the POS device through a network. The advertisement request brokering server registers in a data base in storage means store environment information on the store, transmitted from the POS device, and registers in the storage means advertisement request information and advertising content on the advertiser, transmitted from the advertiser terminal. Based on the advertisement request information, the advertisement request brokering server selects among registered stores a store that satisfies the requirement of the advertiser, and sends the associated advertising content to the POS device of the selected store. Then, the POS device stores the received advertising content and prints the stored advertising content onto a sales receipt.

### FIELD OF THE INVENTION

The present invention relates to an advertisement request brokering system, an advertisement request brokering method, and an advertisement request brokering program for brokering an advertisement request from an advertiser, between the advertiser and a store that runs an advertisement at the request of the advertiser. More specifically, the invention relates to an advertisement request brokering server system, an advertisement brokering method, and an advertisement request brokering program that can advertise content suited to customers targeted by the advertiser.

### BACKGROUND OF THE INVENTION

Up to now, so-called sales receipt advertising has been performed in stores such as convenience stores and supermarkets. In this advertising method, by printing an advertisement on a sales receipt received by a customer at the payment of merchandise, an advertising activity is performed. As the prior art associated with this method, there is devised a technique disclosed in JP Patent Kokai JP-A-2000-322654. In this technique, by means of a point-of-sale (POS) system, advertising content suited to a customer is individually printed on a sales receipt received by the customer, based on information such as age or gender of the customer entered by an operator and identification information such as a bar code attached to merchandise.

Further, on-screen advertising using a customer display has become widespread. In this advertisement method, an advertisement is displayed on a display device installed in a store, and the method of changing advertising content once every given time is known.

Further, an advertising activity by means of an advertisement method such as banner advertising has become widespread. A banner advertisement is run on a space dedicated to advertising on Web-sites such as a web page and a mail magazine on the Internet. By linking the banner advertisement to the web page of an advertiser and then making a selection, detailed information on the advertising content can be obtained.

### SUMMARY OF THE DISCLOSURE

The conventional advertisement methods had the following problems.

A first problem is that, in the sales receipt advertisement, an individual contract has to be made in advance between an advertiser and a store that runs an advertisement, so that it is difficult to perform an advertising activity widely and appropriately, as a matter of fact.

A second problem is that, if a customer does not have means such as a personal computer or a cellular phone for accessing the Internet, the banner advertisement is not effective at all in performing the advertising activity on such a customer.

A third problem is that, since the banner advertisement is highly anonymous, it is not clear that into which type an actual customer is classified, so that it is difficult to promptly and effectively advertise the advertising content suited to the customer. In the banner advertisement using the Internet, whether a customer who browsed the banner is a man or a woman, and the age of the customer cannot always be obtained.

It is therefore an object of the present invention to provide an advertisement request brokering server, an advertisement request brokering method, and an advertisement request brokering program that facilitate making an advertisement contract between an advertiser and a store that runs an advertisement.

Another object of the present invention is to provide an advertisement request brokering server, an advertisement request brokering method, and an advertisement request brokering program that enable an advertising activity even for a customer who does not have means such as a personal computer or a cellular phone.

It is a further object of the present invention to provide an advertisement request brokering server, an advertisement request brokering method, and an advertisement request brokering program that allows an advertisement to be suited to a customer.

The above and other objects of the invention are attained by a system for brokering an advertisement request from an advertiser between said advertiser and a store, said system comprising at least one server node, at least one terminal(termed as an advertiser terminal) used by said advertiser for performing network-communication with said server node, and at least one POS device provided in said store for performing network-communication with said server node, said store running an advertisement in accordance with a request from said advertiser, wherein the server node comprises: means for receiving store environment information sent from said POS device to register said store environment information in a database in storage means therein, said store environment information including at least one of a store name, an address, sales, a customer type, and merchandise to be dealt in by said store in which said POS device is provided;

means for receiving advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;

means for selecting among registered stores a store that satisfies a requirement of said advertiser based on said advertisement request information stored in said storage means; and

means for sending the associated advertising content to said POS device of the selected store.

The POS device in accordance with the present invention comprises: means for receiving said advertising content sent from said server node to store said advertising content in a storage means; and

means for printing said advertising content onto a sales receipt.

In accordance with another second aspect of the present invention, there is provided a system for brokering an advertisement request from an advertiser between said advertiser and a store, said system comprising at least one server node, at least one terminal(termed as an advertiser terminal) used by said advertiser for performing network-communication with said server node, and at least one POS device provided in said store for performing network-communication with said server node, said store running an advertisement in accordance with a request from said advertiser, wherein the server node comprises: means for receiving store environment information sent from said POS device to register said store environment information in a database in storage means therein, said store environment information including at least one of a store name, an address, sales, a customer type, and merchandise to be dealt in by said store in which said POS device is provided;

means for receiving advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;

means for selecting among registered stores a store that satisfies a requirement of said advertiser based on said advertisement request information stored in said storage means; and

means for sending the associated advertising content to said POS device of the selected store.

The POS device in accordance with the present invention comprises: means for receiving said advertisement request information and said advertising content sent from said server node to store said advertisement request information and said advertising content in storage means;

means for inputting information of an age and gender of a purchaser;

means for determining whether the age and the gender of the purchaser inputted match an age and the gender of the advertisement target customer group included in said advertisement request information; and

means for printing out said stored advertising content onto a sales receipt if it is determined that the age and the gender of the purchaser match the age and the gender of the advertisement target customer group.

In accordance with another aspect of the present invention, there is provided a system for brokering an advertisement request from an advertiser between said advertiser and a store, said system comprising at least one server node, at least one terminal(termed as an advertiser terminal) used by said advertiser for performing network-communication with said server node, and at least one POS device provided in said store for performing network-communication with said server node, said store running an advertisement in accordance with a request from said advertiser, wherein the server node comprises: means for receiving store environment information sent from said POS device to register said store environment information in a database in storage means therein, said store environment information including at least one of a store name, an address, sales, a customer type, and merchandise to be dealt in by said store in which said POS device is provided;

means for receiving advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;

means for selecting among registered stores a store that satisfies a requirement of said advertiser based on said advertisement request information stored in said storage means; and

means for sending the associated advertising content to said POS device of the selected store.

The POS device in accordance with the present invention comprises: means for receiving said advertisement request information and the associated advertising content sent from said server node to store said advertisement request information and the associated advertising content in storage means; means for reading an identifier attached to merchandise; means for determining whether the merchandise associated with the read identifier is related to merchandise included in said advertisement request information; and means for printing out said stored advertising content onto a sales receipt if it is determined that the merchandise associated with the read identifier is related to the merchandise included in said advertisement request information.

In the advertisement request broker server in accordance with the present invention, it is preferable that the POS system further comprises advertisement count counting means for counting the number of times the advertising content has been printed on the sales receipt, and that the advertisement request brokering server comprises advertisement count requesting means for periodically requesting an advertisement count indicating how many times the advertising content has been counted for a selected POS system.

In the advertisement request brokering server in accordance with the present invention, it is preferable that the advertisement request brokering server further comprises means for summing up advertisement counts from the selected POS system and calculating an advertising fee for the summed up advertisement counts, and means for sending advertising fee billing information including the summed up advertisement counts and the calculated advertising fee.

In the advertisement request brokering server in accordance with the present invention, it is preferable that the advertisement request brokering server further comprises: means for providing a store environment form prompting entry of the store environment information for the POS system in response to access from the POS system; and means for providing the advertisement request information, an advertisement request form prompting entry of the advertising content, and an advertising content creation form for the advertiser terminal in response to access from the advertiser terminal.

In the advertisement request brokering server in accordance with the present invention, it is preferable that the POS system comprises display means for displaying the stored advertising content on a screen.

In accordance with a further aspect of the present invention, there is provided a method for brokering an advertisement request from an advertiser between said advertiser and a store, by using a server node connected through a network to at least one client terminal(termed as an advertiser terminal) used by said advertiser and connected through a network to at least one POS device provided in said store, said store running an advertisement in accordance with a request from said advertiser, said method comprising the steps of:

receiving, by said server node, store environment information sent from said POS device to register said store environment information in a database in storage means therein, said store environment information including a name, an address, sales, a customer type and merchandise to be dealt in by said store in which said POS device is provided;

receiving, by said server node, advertisement request information and advertising content associated with said advertisement request information, sent from said advertiser terminal to register said advertisement request information and said advertising content in storage means therein, said advertisement request information including a name and an address of said advertiser, a size of a store by which advertising is desired to be run, merchandise to be dealt in by said store, an advertisement target customer group, and gender of the advertisement target customer group, the advertising content including heading characters, an item to be advertised, a font, a character size, and a design;

selecting, by said server node, among registered stores a store that satisfies a requirement of said advertiser based on said advertisement request information;

sending, by said server node, to said POS device in the selected store said advertisement request information and the advertising content associated with said advertisement request information;

receiving, by said POS device, said advertising content sent from said server node to store said advertising content in storage means therein; and

printing, by said POS device, said stored advertising content onto a sales receipt.

In accordance with a further aspect of the present invention, there is provided a method for brokering an advertisement request from an advertiser between said advertiser and a store, by using a server node connected through a network to at least one client terminal(termed as an advertiser terminal) used by said advertiser and connected through a network to at least one POS device provided in said store, said store running an advertisement in accordance with a request from said advertiser, said method comprising the steps of:

receiving, by said server node, store environment information sent from said POS device to register said store environment information in a database in storage means therein, said store environment information including a name, an address, sales, a customer type and merchandise to be dealt in by said store in which said POS device is provided;

receiving, by said server node, advertisement request information and advertising content associated with said advertisement request information, sent from said advertiser terminal to register said advertisement request information and said advertising content in storage means therein, said advertisement request information including a name and an address of said advertiser, a size of a store by which advertising is desired to be run, merchandise to be dealt in by said store, an advertisement target customer group, and gender of the advertisement target customer group, the advertising content including heading characters, an item to be advertised, a font, a character size, and a design;

selecting, by said server node, among registered stores a store that satisfies a requirement of said advertiser based on said advertisement request information;

sending, by said server node, to said POS device in the selected store said advertisement request information and the advertising content associated with said advertisement request information;

receiving, by said POS device, said advertisement request information and the associated advertising content sent from said server node to store said advertisement request information and the associated advertising content in storage means therein;

determining, by said POS device, whether an age and gender of a purchaser inputted match an age and the gender of the advertisement target customer group included in said advertisement request information; and

printing, by said POS device, said stored advertising content onto a sales receipt if it is determined that the age and the gender of the purchaser match the age and the gender of the advertisement target customer group.

In accordance with a further aspect of the present invention, there is provided a method for brokering an advertisement request from an advertiser between said advertiser and a store, by using a server node connected through a network to at least one client terminal(termed as an advertiser terminal) used by said advertiser and connected through a network to at least one POS device provided in said store, said store running an advertisement in accordance with a request from said advertiser, said method comprising the steps of:

receiving, by said server node, store environment information sent from said POS to register said store environment information in a database in storage means therein, said store environment information including a name, an address, sales, a customer type and merchandise to be dealt in by said store in which said POS device is provided;

receiving, by said server node, advertisement request information and advertising content associated with said advertisement request information, sent from said advertiser terminal to register said advertisement request information and said advertising content in storage means therein, said advertisement request information including a name and an address of said advertiser, a size of a store by which advertising is desired to be run, merchandise to be dealt in by said store, an advertisement target customer group, and gender of the advertisement target customer group, the advertising content including heading characters, an item to be advertised, a font, a character size, and a design;

selecting, by said server node, among registered stores a store that satisfies a requirement of said advertiser based on said advertisement request information;

sending, by said server node, to said POS device in the selected store said advertisement request information and the advertising content associated with said advertisement request information;

receiving by said POS device said advertisement request information and the associated advertising content sent from said server node to store said advertisement request information and the associated advertising content in storage means therein;

reading, by said POS device, an identifier attached to merchandise;

determining, by said POS device, whether the merchandise associated with the read identifier is related to merchandise included in said advertisement request information; and printing, by said POS device, said stored advertising content onto a sales receipt if the merchandise associated with the read identifier is related to the merchandise included in said advertisement request information.

In accordance with a further aspect of the present invention, there is provided a computer program product for causing a server node computer to perform brokering an advertisement request from an advertiser between said advertiser and a store, said server node server node computer connected through a network to at least one client terminal(termed as an advertiser terminal) used by said advertiser and connected through said network to at least one POS device provided in said store, said store running an advertisement in accordance with a request from said advertiser, said computer program comprising the steps of:

receiving, by said server node computer, store environment information sent from said POS device to register said store environment information in a database in storage means therein, said store environment information including a name, an address, sales, a customer type of said store, and merchandise to be dealt in by said store in which said POS device is provided;

receiving, by said server node computer advertisement request information and advertising content associated with said advertisement request information, sent from said advertiser terminal to register said advertisement request information and said advertising content in storage means therein, said advertisement request information including a name and an address of said advertiser, a size of a store by which advertising is desired to be run, merchandise to be dealt in by said store, an advertisement target customer group, and gender of the advertisement target customer group, the advertising content including heading characters, an item to be advertised, a font, a character size, and a design;

selecting, by said server node computer, among registered stores a store that satisfies a requirement of said advertiser based on said advertisement request information; and

sending, by said server node computer, to said POS device in the selected store said advertisement request information and the advertising content associated with said advertisement request information.

The computer program product causes said POS device on which the program is run to execute the steps of:

receiving, by said POS device, said advertising content sent from said server node computer to store said advertising content in storage means therein; and

printing, by said POS device, said stored advertising content onto a sales receipt.

In accordance with a further aspect of the present invention, there is provided a computer program product for causing a server node computer to perform brokering an advertisement request from an advertiser between said advertiser and a store, said server node computer connected through a network to at least one client terminal(termed as an advertiser terminal) used by said advertiser and connected through a network to at least one POS device provided in said store, said store running an advertisement in accordance with a request from said advertiser, said computer program comprising the steps of:

receiving, by said server node computer, store environment information sent from said POS device to register said store environment information in a database in storage means therein, said store environment information including a name, an address, sales, a customer type of said store, and merchandise to be dealt in by said store in which said POS device is provided;

receiving, by said server node computer advertisement request information and advertising content associated with said advertisement request information, sent from said advertiser terminal to register said advertisement request information and said advertising content in storage means therein, said advertisement request information including a name and an address of said advertiser, a size of a store by which advertising is desired to be run, merchandise to be dealt in by said store, an advertisement target customer group, and gender of the advertisement target customer group, the advertising content including heading characters, an item to be advertised, a font, a character size, and a design;

selecting, by said server node computer, among registered stores a store that satisfies a requirement of said advertiser based on said advertisement request information; and

sending, by said server node computer, to said POS device in the selected store said advertisement request information and the advertising content associated with said advertisement request information.

The computer program product causes said POS device on which the program is run to execute the steps of:

receiving, by said POS device, said advertisement request information and the associated advertising content sent from said server node computer to store said advertisement request information and the associated advertising content in storage means therein;

determining, by said POS device, whether an age and gender of a purchaser inputted match an age and the gender of the advertisement target customer group included in said advertisement request information; and

printing, by said POS device, said stored advertising content onto a sales receipt if it is determined that the age and the gender of the purchaser match the age and the gender of the advertisement target customer group.

In accordance with a further aspect of the present invention, there is provided a computer program product for causing a server node computer to perform brokering an advertisement request from an advertiser between said advertiser and a store, said server node computer connected through a network to at least one client terminal(termed as an advertiser terminal) used by said advertiser and connected through a network to at least one POS device provided in said store, said store running an advertisement in accordance with a request from said advertiser, said computer program comprising the steps of:

receiving, by said server node computer, store environment information sent from said POS device to register said store environment information in a database in storage means therein, said store environment information including a name, an address, sales, a customer type of said store, and merchandise to be dealt in by said store in which said POS device is provided;

receiving, by said server node computer advertisement request information and advertising content associated with said advertisement request information, sent from said advertiser terminal to register said advertisement request information and said advertising content in storage means therein, said advertisement request information including a name and an address of said advertiser, a size of a store by which advertising is desired to be run, merchandise to be dealt in by said store, an advertisement target customer group, and gender of the advertisement target customer group, the advertising content including heading characters, an item to be advertised, a font, a character size, and a design;

selecting, by said server node computer, among registered stores a store that satisfies a requirement of said advertiser based on said advertisement request information; and

sending, by said server node computer, to said POS device in the selected store said advertisement request information and the advertising content associated with said advertisement request information.

The computer program product causes said POS device on which the program is run to execute the steps of:

receiving, by said POS device, said advertisement request information and the associated advertising content sent from said server node computer to store said advertisement request information and the associated advertising content in storage means therein;

reading, by said POS device, an identifier attached to merchandise;

determining, by said POS device, whether the merchandise associated with the read identifier is related to merchandise included in said advertisement request information; and

printing, by said POS device, said stored advertising content onto a sales receipt if the merchandise associated with the read identifier is related to the merchandise included in said advertisement request information.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram schematically showing a configuration of an advertisement running agency service provision system according to a first embodiment of the present invention;

FIG. 2 is a schematic diagram showing a configuration of a POS system according to the first embodiment of the present invention;

FIG. 3 is a schematic diagram that enlarges a key entry section of the POS system according to the first embodiment of the present invention;

FIG. 4 is a schematic diagram showing a configuration of application software contained in the POS system according to the first embodiment of the present invention;

FIG. 5 is a display schematically showing a store environment form used in the first embodiment of the present invention;

FIG. 6 is a display schematically showing an advertisement request form used in the first embodiment of the present invention;

FIG. 7 is a display schematically showing an advertisement content creation form used in the first embodiment of the present invention; and

FIG. 8 is a flowchart schematically showing an operation of an advertisement request brokering system according to the first embodiment of the present invention.

### PREFERRED EMBODIMENTS OF THE INVENTION

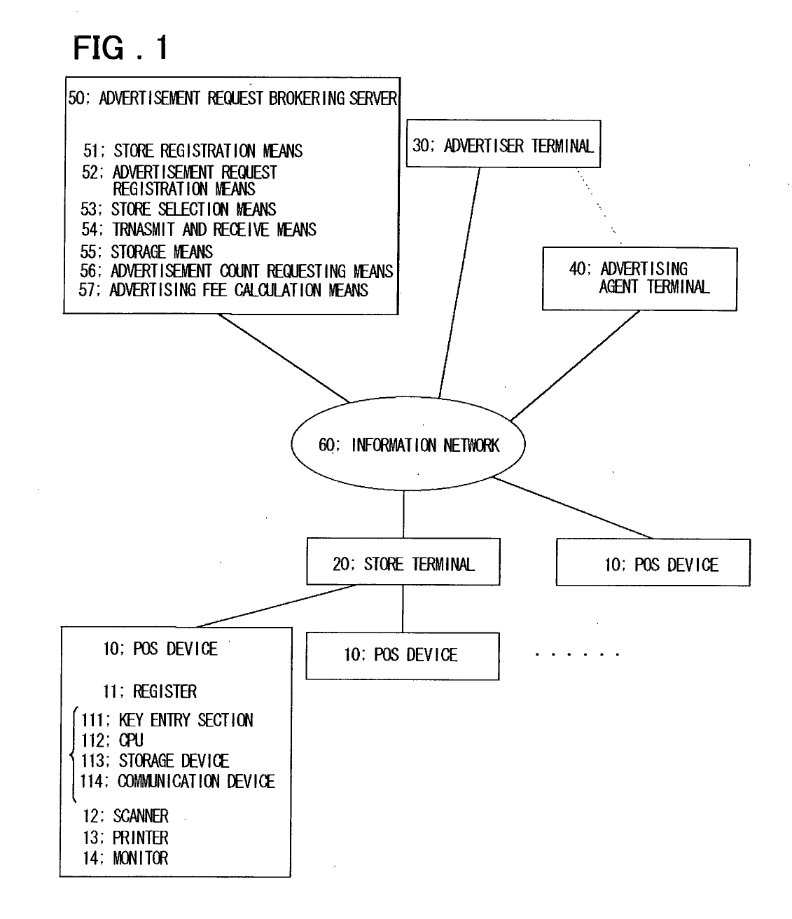

Preferred embodiments of the invention will be described in the below. An advertisement request brokering server indicated by reference numeral 50 in FIG. 1 mediates an advertisement request from an advertiser between the advertiser and a store. The advertisement request brokering server is connected through a network indicated by reference numeral 60 in FIG. 1 to at least one advertiser terminal indicated by reference numeral 30 in FIG. 1, used by the advertiser and is connected through the network to at least one POS system indicated by reference numeral 10 in FIG. 1, installed in the store. The store runs an advertisement at the request of the advertiser. The advertisement request brokering server comprises store registration means indicated by reference numeral 51 in FIG. 1, for registering store environment information transmitted from the POS system, in a database in storage means indicated by reference numeral 55 in FIG. 1. The store environment information includes the name, address, sales, and a customer type of the store, and merchandise to be dealt in by the store. The advertisement request brokering server further comprises advertisement request registration means indicated by reference numeral 52 in FIG. 1, store selection means indicated by reference numeral 53 in FIG. 1, and advertising content transmitting means indicated by reference numeral 54 in FIG. 1. The advertisement request registration means registers advertisement request information and advertising content in the storage means indicated by reference numeral 55 in FIG. 1. The advertisement request information includes the name, address of the advertiser, size of a store by which advertising is desired to be run, merchandise to be dealt in by the store, an advertisement target customer group, and gender of the target customer group. The advertising content includes heading characters, an item to be advertised, a font, a character size, and a design. The store selection means selects among registered stores a store that satisfies a requirement of the advertiser based on the advertisement request information, and advertising content transmitting means transmits the advertising content associated with the selected store to the POS system. The POS system indicated by reference numeral 10 in FIG. 1 comprises storage means indicated by reference numeral 113 in FIG. 1, for storing the advertising the received content, and printing means indicated by reference numeral 13 in FIG. 1, for printing the stored advertising content onto a sales receipt. With this arrangement, mediation between an advertiser and a store that has never done business dealings with the advertiser can be simply performed. Further, the advertiser can perform an advertising activity for the store without going all the way to the store.

According to the other embodiment of the present invention, individual processing on the server is carried out by execution of a program on a computer that constitutes the server. In this case, from a recording medium that has recorded the program, the program is read into the computer through a machine reading device and an interface for the recording medium, and then loaded into a main storage for execution, thereby allowing the invention to be practiced. As the recording medium, a magnetic disk such as a flexible disk or a hard disk, a magnetic tape, an optical disk such as a compact disk (CD)-ROM, a digital versatile disk (DVD), or semiconductor memory can be pointed out. Alternatively, the program may be transmitted from the storage of other computer through a wired or wireless network medium and communication interface, installed into the computer, and then loaded into the main storage for execution.

A first embodiment will be described in detail with reference to the FIG. 1 to FIG. 8.

Referring to FIG. 1, the advertisement request brokering system comprises a POS system 10, an advertiser terminal 30, an advertisement request brokering server node 50, and an information network 60. This advertisement request brokering system comprises a store terminal 20 for integrating a plurality of the POS systems 10 if they are present in a store and an advertisement agency terminal 40 used by an advertisement agent that creates the advertisement of an advertiser on behalf of the agent.

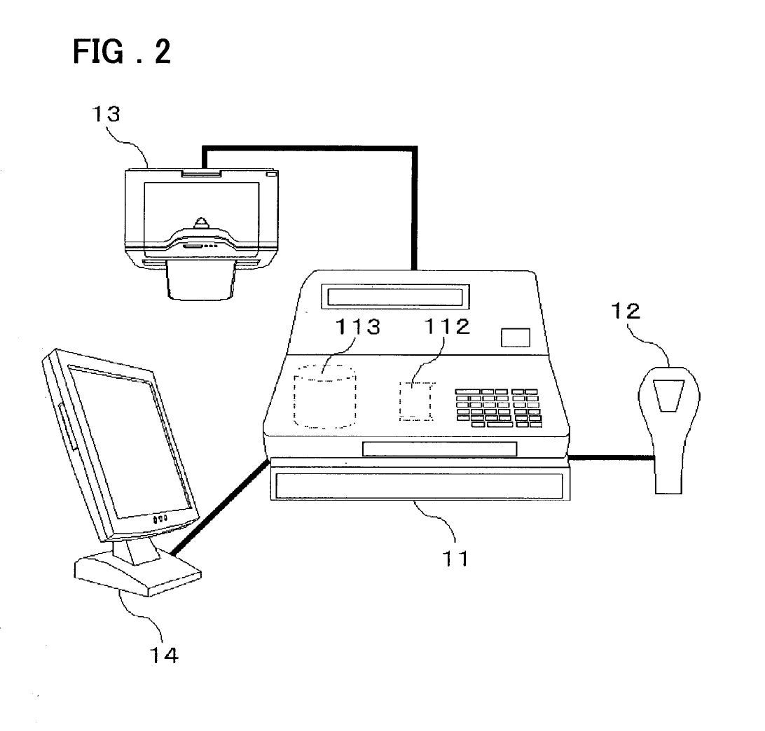

Referring to FIG. 2, in order to track which merchandise was sold in the store, when was that merchandise sold, and how many pieces of that merchandise were sold, the POS system 10 collects information for each piece of merchandise at the point of sale thereof and controls the information using a computer. The POS system is connected to the information network 60 directly through a communication device such as a modem device or a LAN(Local Area Network) device or indirectly through the store terminal 20. The POS system comprises a register 11, a scanner 12, a printer 13, and a monitor 14.

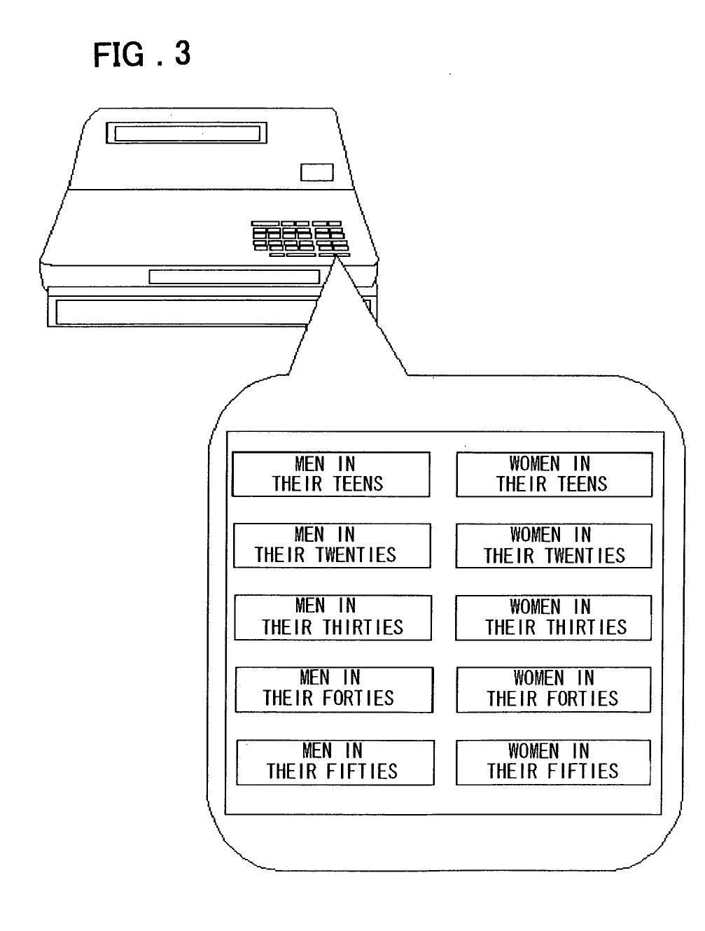

The register 11 is a computer-based register, and comprises a key entry unit 111, a central processing unit (CPU) 112, a storage device 113, and a communication device 114. The key entry unit 111 includes buttons for identifying customer types. Settings according to the age and gender of a customer, as shown in FIG. 3, for example, may be made. The CPU 112 compares information such as the age and gender of a customer, entered by an operator or identification information, with advertisement request information received from the advertisement request brokering server 50. The identification information is associated with a bar code attached to merchandise, read by the scanner 12. The advertisement request information includes information on the age, gender of a target customer, and merchandise. If the above-mentioned information or identification information matches the advertisement request information, the CPU causes the printer 13 to print the associated advertising content or causes the monitor 14 to display the advertising content, counts the number of times the advertising content was run, and causes the information associated with the advertisement count to be transmitted at the request of the advertisement request brokering server 50. The number of times the advertising content was run includes such information as the number of sales receipts printed, the number of times and the period of time display was made. The storage device 113 stores the advertisement request information received from the advertisement request brokering server 50, the advertising content associated with the advertisement request information, and information including the advertisement count indicating how many times the advertising content has been counted. The communication device 114 receives and transmits predetermined information. The communication device 114 receives advertisement request data and the advertising content associated therewith, transmitted from the advertisement request brokering server 50, and transmits the advertisement count for the advertising content to the advertisement request brokering server 50.

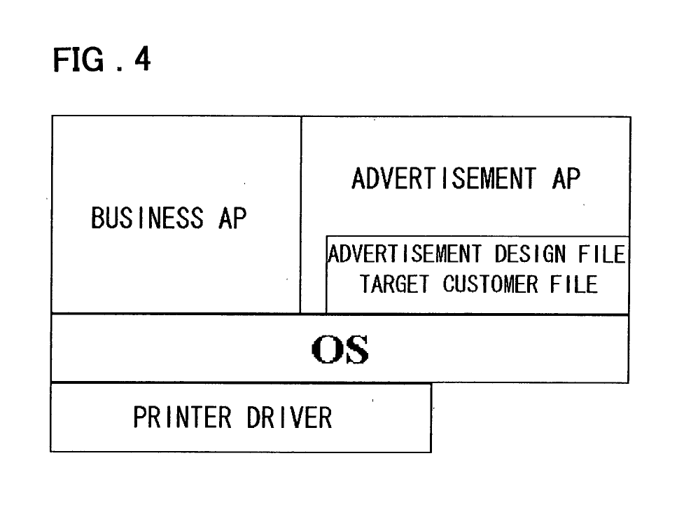

FIG. 4 is a configuration of application software contained in the POS system. Conventional business-application software, an operating system, and a printer driver are used in the POS system, and advertising application software causes an advertising design created by an advertiser to be printed, using a printer. Further, the advertising application software stores advertisement request information and the advertising content or an advertising design file in the storage device.

The scanner 12 is a device for reading a bar code attached to merchandise or a tag, and is connected to the register 11. The printer 13 is connected to the register 11, and in response to a command from the register 11, the printer 13 prints the content of the command onto a sales receipt. The monitor 14 is a display device that displays predetermined content under the control of the register 11, being connected to the register 11. If the POS system 10 is not directly connected to the information network 60, data transfer to the POS system 10 may be made using a flexible disk through the store terminal 20 equipped with a communication device.

The store terminal 20 is a computer terminal used in a store, being connected to the information network 60. The store terminal 20 is connected to the POS system 10, depending on the case. If the POS system 10 is directly connected to the information network 60, it is not necessary to provide the store terminal 20.

The advertiser terminal 30 is a computer terminal used by an advertiser, and is connected to the information network 60. If the advertiser receives advertisement request brokering service through an advertising agent, it is not necessary to provide the advertiser terminal 30.

The advertising agent terminal 40 is a computer terminal used by an advertising agent, and is connected to the information network 60. If an advertiser receives advertisement request brokering service using his own terminal, it is not necessary to provide the advertising agent terminal 40.

The advertisement request brokering server 50 is a server that becomes a dedicated site for automatically performing mediation between an advertiser and a store that runs an advertisement, and is connected to the information network 60. The advertisement request brokering server 50 comprises store registration means 51, advertisement request registration means 52, store selection means 53, transmit and receive means 54, storage means 55, advertisement count requesting means 56, and advertising fee calculation means 57.

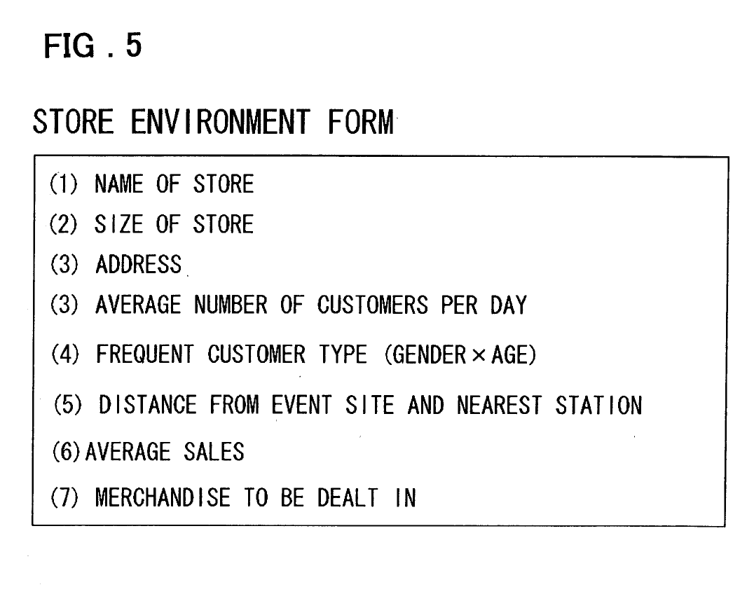

The store registration means 51 provides a store environment form (see FIG. 5) for the POS system 10 or store terminal 20 that made access thereto, receives store environment information including the name, address, sales, a customer type of a store, and merchandise to be dealt in by the store entered in the provided store environment form, and registers these information in a data base in the storage means 55.

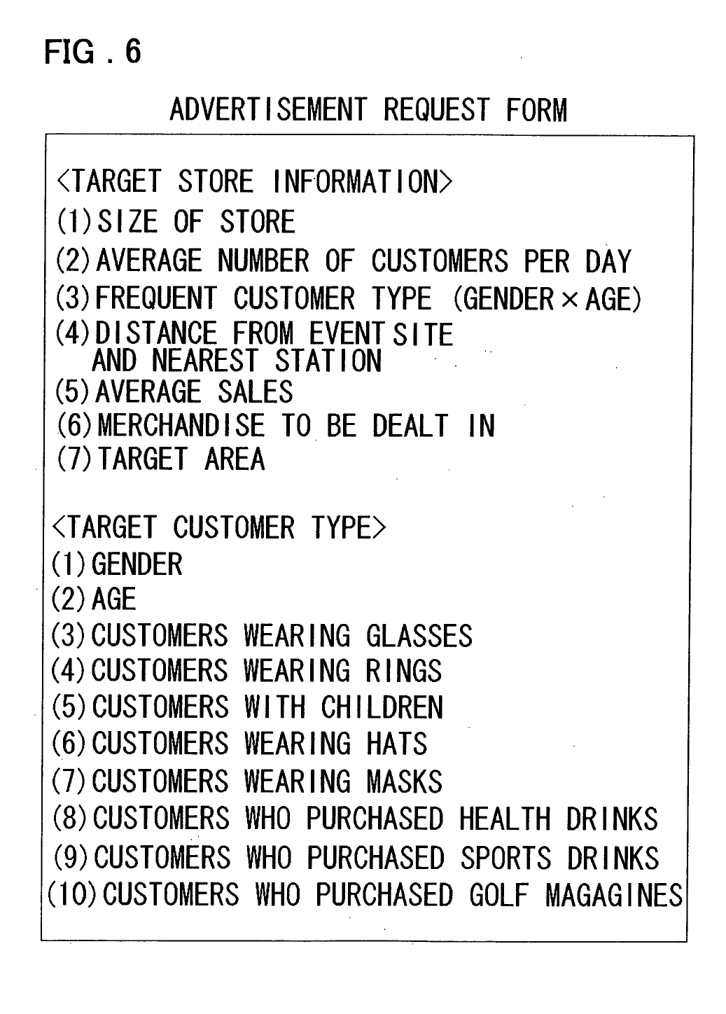

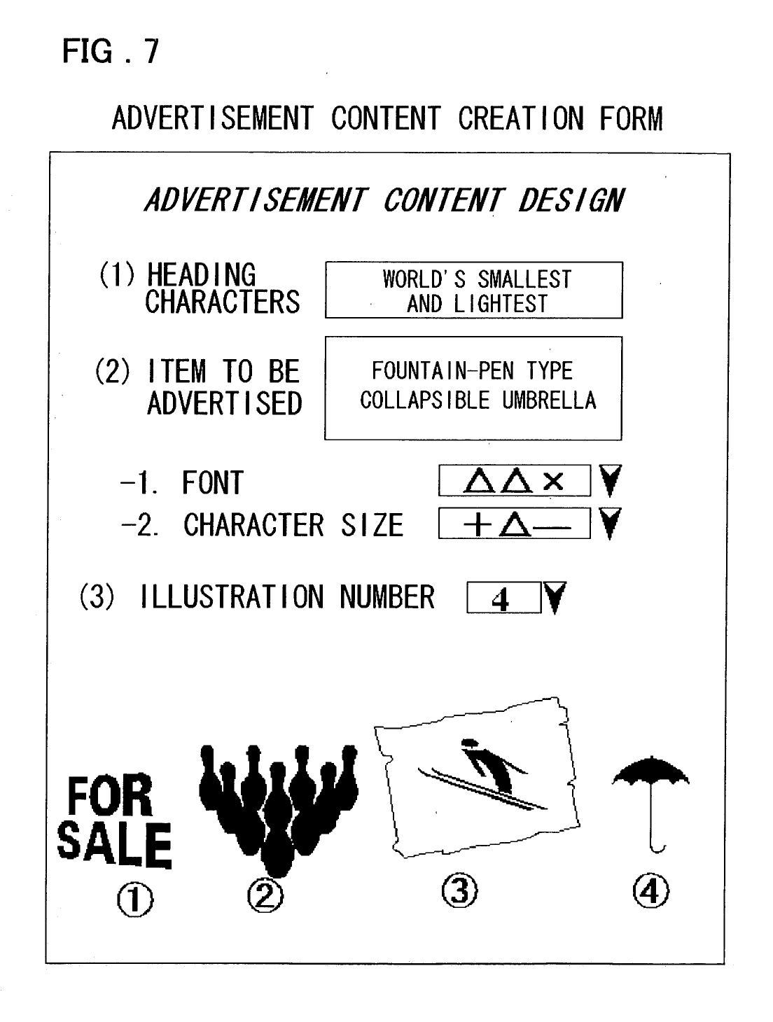

The advertisement request registration means 52 provides an advertisement request form (see FIG. 6) and an advertising content creation form (see FIG. 7) for the advertiser terminal 30 or advertising agent terminal 40 that made access thereto, receives advertisement request information and the advertising content associated therewith, and registers these information in the storage means 55. The advertisement request information includes the name, address, and location of the advertiser, size of a store by which the advertisement of the company is desired to be run, frequent customer type of the store, number and gender of customers who visit the store, and the distance from the nearest station and an event site. The advertising content includes heading characters, an item to be advertised, a font, a character size, and a design.

The store selection means 53 selects among registered stores a store matched to the requirements desired by an advertiser, based on the advertisement request information.

The transmit and receive means 54 sends advertisement request information and advertising content to a selected POS system 10 or store terminal 20, receives from the POS system 10 the number of times the advertisement content was advertised, and sends to the advertiser terminal 30 or advertising agent terminal 40 associated with the advertising content information on the total advertisement count and an advertising fee for the advertising content.

The storage means 55 stores store environment information, advertisement request information, and information on advertising content associated with the advertisement request information and the advertisement count for the advertising content.

The advertisement count requesting means 56 periodically requests transmission of information including an advertisement count indicating how many times the advertising content has been counted for each of selected POS systems or selected store terminals 20. The advertisement count herein refers to the number of counts obtained by subtracting the number of counts requested last from the number of counts currently requested.

The advertising fee calculation means 57 receives the advertisement counts for the advertising content sent by the selected POS systems 10 or the selected store terminals 20, thereby summing up the advertisement counts and then calculates the advertising fee for the total count.

The information network 60 is an information communication network such as the Internet.

Next, an operation according to the first embodiment will be described with reference to an appended drawing.

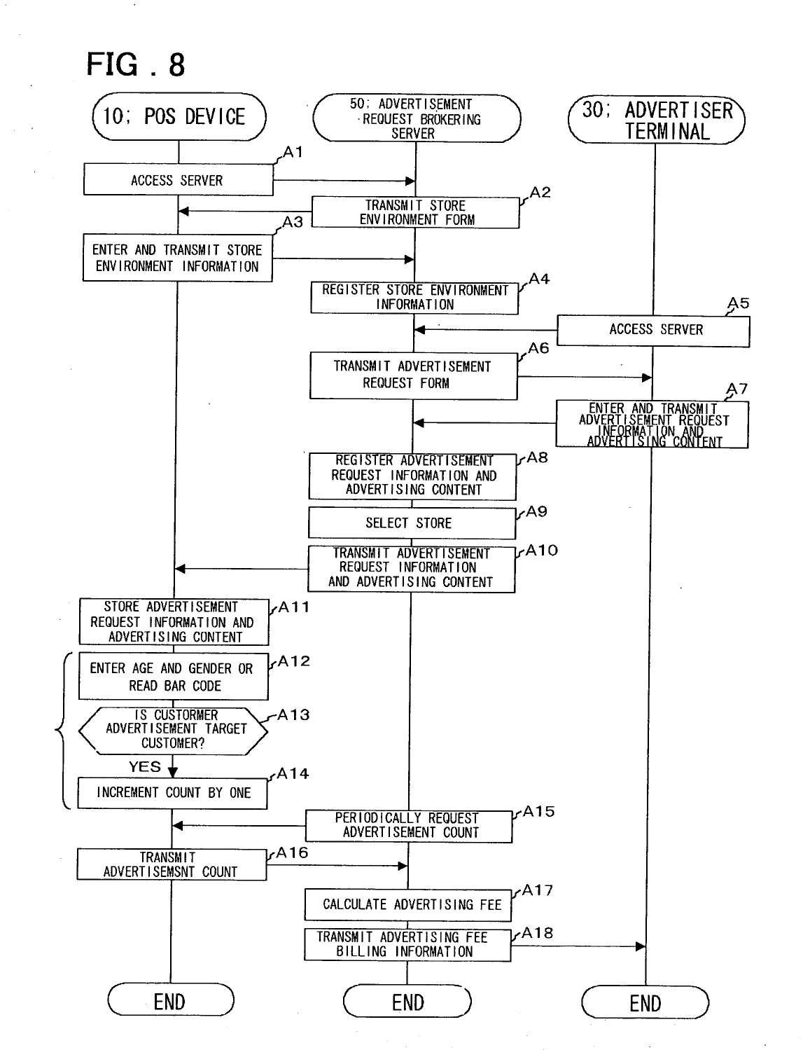

Referring to FIG. 8, a store manager who will run an advertisement or in charge of the advertisement first registers his membership for advertisement request brokering service. The store manager accesses the advertisement request brokering server 50 through the POS system 10 or the store terminal in step A1. Then, the store manager acquires the store environment form (refer to FIG. 5) from the advertisement request brokering server 50 in step A2. Then, the store manager enters into the store environment form store environment information including the name, address, location, sales, and frequent customer type of his own store, and merchandise to be dealt in by the store, and then transmits the entered store environment information to the advertisement request brokering server 50 in step A3. Next, by receiving the store environment information, the advertisement request brokering server 50 stores the store environment information in a database in the storage device in step A4. Incidentally, the administrator of the advertisement request brokering server 50 may check the store environment information to eliminate fraud such as counterfeiting.

Next, an advertiser accesses the advertisement request brokering server 50 through his own advertiser terminal 30 or the advertising agent terminal in step A5. Then, the advertiser acquires the advertisement request form (refer to FIG. 6) and the advertising content creation form (refer to FIG. 7) from the advertisement request brokering server 50 in step A6. The advertiser then enters into the advertisement request form advertisement request information including the name, address, location of his own company, size of a store by which advertising is desired to be run, frequent customer type of the store, number of customers who visit the store in a day, the distance from the nearest station and an event site to the store, gender of advertisement target customers, and then creates advertising content associated with these data items, such as characters and a design. Thereafter, the advertiser transmits the entered advertisement request information and the associated advertising content to the advertisement request brokering server 50 in step A7. Next, the advertisement request brokering server 50 receives the advertisement request information and the associated advertising content, thereby registers the advertisement request information and the associated advertising content in the storage device in step A8. With this arrangement, information on the store by which the advertiser desires the advertisement to be carried, or target store information and customers for whom the advertiser actually desires to run advertising or the type of target customers are registered in the advertisement request brokering server 50. Incidentally, the administrator of the advertisement request brokering server 50 may check the advertisement request information and the associated advertising content to eliminate fraud.

A design for the advertising content should be in accordance with the advertising content creation form as shown in FIG. 7 provided from the advertisement request agent server 50. An advertising creator can readily complete the design by entering heading characters, an item to be advertised, a font, and a character size and then specifying an illustration number in the form. Since the advertising content is printed onto a sales receipt by the POS system, a format or an illustration design taking the width of the sales receipt and printing time into consideration in advance should be developed for supply to the advertisement request brokering server 50.

Next, the advertisement request brokering server 50 searches store environment information registered in advance, based on advertisement request information, and selects a store customers targeted by the advertiser many times visit, in step A9. Next, the advertisement request brokering server 50 sends the associated advertising content created by the advertiser (advertising agent) and the advertisement request information to all the POS systems 10 or all the store terminals in the selected store, in step A10.

Next, the POS systems 10 in the selected store the associated advertising content and the advertisement request information in step A11. With this arrangement, when a target customer registered in the advertisement request information visits the selected store, a POS system 10 in the selected store reads entry of an operator or a bar code attached to merchandise at the payment of the merchandise, in step A12. Then, the POS system 10 thereby compares the read information with the advertisement request information to confirm whether the customer is the advertisement target customer, in step A13. If the customer is the advertisement target customer, or an affirmative response is obtained in step A13, the POS system prints the advertising content onto a sales receipt and increments the advertisement count for the advertising content by one, in step A14. If the customer is not the advertisement target customer, the advertising content is not printed onto the sales receipt. By repeating the steps A12 to A14, the advertisement count is incremented.

Next, the advertisement request brokering server 50 periodically (once in every month or daily) requests the advertisement count indicating how many times the advertising content has been counted for the POS system 10 in the store, in step A15. The respective POS systems 10 that received the request from the advertisement request brokering server 50 send the advertisement count for the advertising content to the advertisement request brokering server 50 in step A16. The advertisement request brokering server 50 sums up the advertisement counts for the advertising content transmitted from the associated POS systems 10 and calculates an advertising fee for the summed advertisement counts in step A17.

Finally, the advertisement request brokering server 50 sends advertising fee billing information including the advertisement count for the advertising content of which the advertisement was requested to be run and the advertising fee therefor to the terminal 30 of the associated advertiser, in step A18.

With this arrangement, the advertiser pays the advertising fee to the administrator of the advertisement request brokering server 50. The administrator of the advertisement request brokering server 50 collects the cost of running a site from the advertiser and also pays the advertising fee to each of the stores according to the advertisement count.

Next, a second embodiments of the present invention will be described.

The basic configuration of a second embodiment is the same as that of the first embodiment. According to the second embodiment, however, a store A such as the manager of a cleaning store is adapted to be able to cause a store B such as a tailor store, which is associated with the store A to run the advertisement of his own store A. On the contrary, the advertisement of the store B can be run by the store A as well, so that a synergistic effect on regional sales can be expected. According to the second embodiment, in order to construct such a system, when store membership registration is performed using the advertisement request brokering server, selection of stores for which the greatest synergistic effect can be expected can be made, based on the addresses of stores and information on merchandises to be dealt in, contained in the store environment information. Further, if an agreement is made between both of store managers, there can be provided an advertisement request brokering system from which the synergistic effect is expected.

The basic configuration of the third embodiment of the present invention is the same as that of the first embodiment. According to the third embodiment, however, it also becomes possible to change the advertising content on a sales receipt according to merchandise purchased by a customer. To take an example, if a ticket seller has an unsold ticket, it should be arranged such that advertising on a sales receipt be run for a customer who would highly probably purchase the ticket. If the unsold ticket is the one for traveling, the customer who purchased a traveling magazine would highly probably purchase the ticket. In order to make such arrangement, the hobby of a customer or merchandise purchased by the customer may also be specified in the advertisement request form.

The basic configuration of a fourth embodiment of the present invention is the same as that of the first embodiment. According to the fourth embodiment, however, the administrator of the advertisement request brokering server may also design an advertisement for an advertiser at the request of the advertiser, and then may use it as the advertisement on a sales receipt in a selected store. In this case, the administrator of the advertisement request brokering server obtains a designing support fee from the advertiser.

The basic configuration of a fifth embodiment of the present invention is the same as that of the first embodiment. According to the fifth embodiment, however, the system is adapted to add an advertising fee according to the number of prints produced in a store. The advertising fee may also be fixed by defining an advertising period.

The basic configuration of a sixth embodiment of the present invention is the same as that of the first embodiment. According to the sixth embodiment, however, as an advertising method in a store, a customer LCD screen in an existing POS system as well as a sales receipt can also be used to carry an advertisement.

The basic configuration of a seventh embodiment of the present invention is the same as that of the first embodiment. According to the seventh embodiment, however, store managers who will run an advertisement may also modify the store environment information according to a change in a store environment.

The meritorious effects of the present invention are summarized as follows.

The first effect of the invention is that an advertiser can advertise the advertising content to a target customer. This is because, by using the store environment information and the advertisement request information, the advertiser can select the most effective store. This makes it possible for the advertiser to use a POS system in the store of a third party, which the target customer would highly probably visit and then to run advertising.

The second effect of the present invention is that a link between an advertiser and a store, which have never had business dealings with each other, can be established through the medium of the Internet. This is because all the procedures for the business dealings can be completed by the advertisement request brokering server. Further, since the advertisement request brokering server accesses a store manager on behalf of the advertiser, the advertiser does not have to go all the way to the store, and can have advertising activities done by the store. This reduces the burden on the advertiser.

The third effect of the present invention is that, since an advertisement is printed on a sales receipt after a customer purchased merchandise in a store, effective sales receipt advertising can be performed. Among the advertising methods using the Internet is banner advertising. When a customer has no means such as a personal computer terminal for accessing the Internet, he or she cannot recognize an advertisement. In such a case, sales receipt advertising in accordance with the present invention, is effective.

The fourth effect of the present invention is that a store manager can obtain an advertising fee revenue. This is because an advertiser pays an advertising fee to the store manager according to the number of sales receipt prints produced in a store.

The fifth effect of the present invention is that an advertiser can reduce the cost of advertising. This is because according to a customer type and merchandise purchased, selective advertising can be performed, so that advertising does not need to be performed for a customer group for whom advertising is not necessary.

The sixth effect of the present invention is that, since materials and forms such as an illustration for making it useful to create advertising content are provided for the advertisement request brokering server, a store proprietor can create the advertising content for his own store using the materials in the advertisement request brokering server, and runs advertising in his store. The store proprietor can simplify a special design such as the one used in sales receipt advertising. Further, the store proprietor can also change the advertising content in real time.

The seventh effect of the present invention is that, just by operating a POS system or performing customer group classification in the same way as done ever before, a sales clerk in a store can reliably classify customers into groups for an advertising purpose.

The eighth effect of the present invention is that, since sales receipt advertising is performed after a customer has purchased merchandise, the customer can recognize an advertisement even if he does not possess specific equipment such as a personal computer or a cellular phone.

The ninth effect of the present invention is that by cooperation from a sales clerk in a store, the identification rate of customer groups can be improved. This is because, through cooperation from the sales clerk in a store and using the Internet, advertising for a target customer group in accordance with the advertisement request form becomes possible. To take examples, it can be so arranged that the advertisement of contact lenses be performed for a customer who wears glasses. Alternatively, it can also be so arranged that advertising traveling in a pair be performed for a customer with a wedding ring on his or her finger.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A system for brokering an advertisement request from an advertiser between said advertiser and a store, said system comprising at least one server node, at least one terminal(termed as an advertiser terminal) used by said advertiser for performing network-communication with said server node, and at least one POS device provided in said store, said POS device performing network-communication with said server node, said store running an advertisement in accordance with a request from said advertiser,
wherein said server node comprises:
means for receiving store environment information sent from said POS device to register said store environment information in a database in storage means therein, said store environment information including at least one of a store name, an address, sales, a customer type and merchandise to be dealt in by said store in which said POS device is provided;
means for receiving advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;
means for selecting among registered stores a store that satisfies a requirement of said advertiser based on said advertisement request information stored in said storage means; and
means for sending the associated advertising content to said POS device of the selected store; and
wherein said POS device comprises:
means for receiving said advertising content sent from said server node to store said advertising content in a storage means; and
means for printing said advertising content onto a sales receipt.

2. A system for brokering an advertisement request from an advertiser between said advertiser and a store, said system comprising at least one server node, at least one terminal(termed as an advertiser terminal) used by said advertiser for performing network-communication with said server node, and at least one POS device provided in said store, said POS device performing network-communication with said server node, said store running an advertisement in accordance with a request from said advertiser,
wherein said server node comprises:
means for receiving store environment information sent from said POS device to register said store environment information in a database in storage means therein, said store environment information including at least one of a store name, an address, sales, a customer type and merchandise to be dealt in by said store in which said POS device is provided;
means for receiving advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;
means for selecting among registered stores a store that satisfies a requirement of said advertiser based on said advertisement request information stored in said storage means; and
means for sending the associated advertising content to said POS device of the selected store; and
wherein said POS device comprises:
means for receiving said advertisement request information and said advertising content sent from said server node to store said advertisement request information and said advertising content in storage means;
means for inputting information of an age and gender of a purchaser;
means for determining whether the age and the gender of the purchaser inputted match an age and the gender of the advertisement target customer group included in said advertisement request information; and
means for printing out said stored advertising content onto a sales receipt if it is determined that the age and the gender of the purchaser match the age and the gender of the advertisement target customer group.

3. A system for brokering an advertisement request from an advertiser between said advertiser and a store, said system comprising at least one server node, at least one terminal(termed as an advertiser terminal) used by said advertiser for performing network-communication with said server node, and at least one POS device provided in said store, said POS device performing network-communication with said server node, said store running an advertisement in accordance with a request from said advertiser,
wherein said server node comprises:
means for receiving store environment information sent from said POS device to register said store environment information in a database in storage means therein, said store environment information including at least one of a store name, an address, sales, a customer type and merchandise to be dealt in by said store in which said POS device is provided;
means for receiving advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;
means for selecting among registered stores a store that satisfies a requirement of said advertiser based on said advertisement request information stored in said storage means; and
means for sending the associated advertising content to said POS device of the selected store; and
wherein said POS device comprises:
means for receiving said advertisement request information and the associated advertising content sent from said server node to store said advertisement request information and the associated advertising content in storage means;
means for reading an identifier attached to merchandise;
means for determining whether the merchandise associated with the read identifier is related to merchandise included in said advertisement request information; and
means for printing out said stored advertising content onto a sales receipt if it is determined that the merchandise associated with the read identifier is related to the merchandise included in said advertisement request information.

4. The system according to claim 1, wherein said POS device further comprises means for counting a number of times said advertising content has been printed on the sales receipt, and
wherein said server node comprises means for periodically requesting an advertisement count indicating how many times said advertising content has been counted for a selected POS device.

5. The system according to claim 4, wherein said server node comprises:
means for summing up advertisement counts from said selected POS device and calculating an advertising fee for the summed up advertisement counts; and
means for sending advertising fee billing information including the advertisement counts and the calculated advertising fee.

6. The system according to claim 1, wherein said server node further comprises:
means for providing a store environment form prompting entry of said store environment information for said POS device in response to access from said POS device; and
means for providing an advertisement request form and an advertising content creation form prompting entry of said advertisement request information and said advertising content for said advertiser terminal in response to access from said advertiser terminal.

7. The system according to claim 1, wherein
said POS device comprises display means for displaying said stored advertising content on a screen.

8. A method for brokering an advertisement request from an advertiser between said advertiser and a store, by using a server node connected through a network to at least one terminal(termed as an advertiser terminal) used by said advertiser and connected through a network to at least one POS device provided in said store, said store running an advertisement in accordance with a request from said advertiser, said method comprising the steps of:
receiving, by said server node, store environment information sent from said POS device to register said store environment information in a database in storage means therein, said store environment information including at least one of a store name, an address, sales, a customer type and merchandise to be dealt in by said store in which said POS device is provided;
receiving, by said server node, advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;
selecting, by said server node, among registered stores a store that satisfies a requirement of said advertiser based on said advertisement request information;
sending, by said server node, to said POS device in the selected store said advertisement request information and the advertising content associated with said advertisement request information;
receiving, by said POS device, said advertising content sent from said server node to store said advertising content in storage means therein; and
printing, by said POS device, said stored advertising content onto a sales receipt.

9. A method for brokering an advertisement request from an advertiser between said advertiser and a store, by using a server node connected through a network to at least one terminal(termed as an advertiser terminal) used by said advertiser and connected through a network to at least one POS device provided in said store, said store running an advertisement in accordance with a request from said advertiser, said method comprising the steps of:
receiving, by said server node, store environment information sent from said POS device to register said store environment information in a database in storage means therein, said store environment information including at least one of a store name, an address, sales, a customer type and merchandise to be dealt in by said store in which said POS device is provided;
receiving, by said server node, advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;
selecting, by said server node, among registered stores a store that satisfies a requirement of said advertiser based on said advertisement request information;
sending, by said server node, to said POS device in the selected store said advertisement request information and the advertising content associated with said advertisement request information;
receiving, by said POS device, said advertisement request information and the associated advertising content sent from said server node to store said advertisement request information and the associated advertising content in storage means therein;
determining, by said POS device, whether an age and gender of a purchaser inputted match an age and the gender of the advertisement target customer group included in said advertisement request information; and
printing, by said POS device, said stored advertising content onto a sales receipt if it is determined that the age and the gender of the purchaser match the age and the gender of the advertisement target customer group.

10. A method for brokering an advertisement request from an advertiser between said advertiser and a store, by using a server node connected through a network to at least one terminal(termed as an advertiser terminal) used by said advertiser and connected through a network to at least one POS device provided in said store, said store running an advertisement in accordance with a request from said advertiser, said method comprising the steps of:
receiving, by said server node, store environment information sent from said POS device to register said store environment information in a database in storage means therein, said store environment information including at least one of a store name, an address, sales, a customer type and merchandise to be dealt in by said store in which said POS device is provided;
receiving, by said server node, advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;
selecting, by said server node, among registered stores a store that satisfies a requirement of said advertiser based on said advertisement request information;
sending, by said server node, to said POS device in the selected store said advertisement request information and the advertising content associated with said advertisement request information;
receiving by said POS device said advertisement request information and the associated advertising content sent from said server node to store said advertisement request information and the associated advertising content in storage means therein;
reading, by said POS device, an identifier attached to merchandise;
determining, by said POS device, whether the merchandise associated with the read identifier is related to merchandise included in said advertisement request information; and
printing, by said POS device, said stored advertising content onto a sales receipt if the merchandise associated with the read identifier is related to the merchandise included in said advertisement request information.

11. The method according to claim 8 , further comprising the steps of:
counting a number of times said advertising content has been printed on the sales receipt, by said POS device; and
periodically requesting, by said server node, an advertisement count indicating how many times said advertising content has been counted for a selected POS device.

12. The method according to claim 11, further comprising the steps of:
summing up, by said server node, advertisement counts from said selected POS device and calculating an advertising fee for the summed up advertisement counts; and
sending, by said server node, advertising fee billing information including the summed up advertisement counts and the calculated advertising fee.

13. The method according to claim 8, further comprising:
providing, by said server node, a store environment form prompting entry of said store environment information for said POS device in response to access from said POS device; and
providing, by said server node, an advertisement request form and an advertising content creation form prompting entry of said advertisement request information and said advertising content for said advertiser terminal in response to access from said advertiser terminal.

14. The method according to claim 8, further comprising the step of:
displaying, by said POS device, said stored advertising content on a screen.

15. A computer program product for causing a server node computer to perform brokering an advertisement request from an advertiser between said advertiser and a store, said server node server node computer connected through a network to at least one terminal(termed as an advertiser terminal) used by said advertiser and connected through said network to at least one POS device provided in said store, said store running an advertisement in accordance with a request from said advertiser, said computer program comprising the steps of:
receiving, by said server node computer, store environment information sent from said POS device to register said store environment information in a database in storage means therein, said store environment information including at least one of a store name, an address, sales, a customer type of said store, and merchandise to be dealt in by said store in which said POS device is provided;
receiving, by said server node computer advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;
selecting, by said server node computer, among registered stores a store that satisfies a requirement of said advertiser based on said advertisement request information;
sending, by said server node computer, to said POS device in the selected store said advertisement request information and the advertising content associated with said advertisement request information;
receiving, by said POS device, said advertising content sent from said server node computer to store said advertising content in storage means therein; and
printing, by said POS device, said stored advertising content onto a sales receipt.

16. A computer program product for causing a server node computer to perform brokering an advertisement request from an advertiser between said advertiser and a store, said server node computer connected through a network to at least one terminal(termed as an advertiser terminal) used by said advertiser and connected through a network to at least one POS device provided in said store, said store running an advertisement in accordance with a request from said advertiser, said computer program comprising the steps of:
receiving, by said server node computer, store environment information sent from said POS device to register said store environment information in a database in storage means therein, said store environment information including at least one of a store name, an address, sales, a customer type of said store, and merchandise to be dealt in by said store in which said POS device is provided;
receiving, by said server node computer advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;
selecting, by said server node computer, among registered stores a store that satisfies a requirement of said advertiser based on said advertisement request information;
sending, by said server node computer, to said POS device in the selected store said advertisement request information and the advertising content associated with said advertisement request information;
receiving, by said POS device, said advertisement request information and the associated advertising content sent from said server node computer to store said advertisement request information and the associated advertising content in storage means therein;
determining, by said POS device, whether an age and gender of a purchaser inputted match an age and the gender of the advertisement target customer group included in said advertisement request information; and
printing, by said POS device, said stored advertising content onto a sales receipt if it is determined that the age and the gender of the purchaser match the age and the gender of the advertisement target customer group.

17. A computer program product for causing a server node computer to perform brokering an advertisement request from an advertiser between said advertiser and a store, said server node computer connected through a network to at least one terminal(termed as an advertiser terminal) used by said advertiser and connected through a network to at least one POS device provided in said store, said store running an advertisement in accordance with a request from said advertiser, said computer program comprising the steps of:
receiving, by said server node computer, store environment information sent from said POS device to register said store environment information in a database in storage means therein, said store environment information including at least one of a store name, an address, sales, a customer type of said store, and merchandise to be dealt in by said store in which said POS device is provided;
receiving, by said server node computer advertisement request information and advertising content associated with said advertisement request information, sent from said advertiser terminal to register said advertisement request information and said advertising content in storage means therein, said advertisement request information including at least one of a name of said advertiser, an address of said advertiser, a size of a store by which advertising is desired to be run, merchandise to be dealt in by said store, an advertisement target customer group, and gender of the advertisement target customer group, the advertising content including at least one of heading characters, an item to be advertised, a font, a character size and a design;
selecting, by said server node computer, among registered stores a store that satisfies a requirement of said advertiser based on said advertisement request information;
sending, by said server node computer, to said POS device in the selected store said advertisement request information and the advertising content associated with said advertisement request information;
receiving, by said POS device, said advertisement request information and the associated advertising content sent from said server node computer to store said advertisement request information and the associated advertising content in storage means therein;
reading, by said POS device, an identifier attached to merchandise;
determining, by said POS device, whether the merchandise associated with the read identifier is related to merchandise included in said advertisement request information; and
printing, by said POS device, said stored advertising content onto a sales receipt if the merchandise associated with the read identifier is related to the merchandise included in said advertisement request information.

18. The computer program product according to claim 15, further comprising the steps of:
counting, by said POS device, a number of times said advertising content has been printed on the sales receipt; and
periodically requesting, by said server node computer, an advertisement count indicating how many times said advertising content has been counted for a selected POS device.

19. The computer program product according to claim 18, further comprising the steps of:
summing up, by said server node computer, advertisement counts from said selected POS device and calculating an advertising fee for the summed up advertisement counts; and
sending, by said server node computer, advertising fee billing information including the summed up advertisement counts and the calculated advertising fee.

20. The computer program product according to claim 15, further comprising the steps of:
providing, by said server node computer, a store environment form prompting entry of said store environment information for said POS device in response to access from said POS device; and
providing, by said server node computer, an advertisement request form and an advertising content creation form prompting entry of said advertisement request information and said advertising content for said advertiser terminal in response to access from said advertiser terminal.

21. The computer program product according to claim 15, further comprising:
displaying, by said POS device, said stored advertising content on a screen.

22. The system according to claim 2, wherein said POS device further comprises means for counting a number of times said advertising content has been printed on the sales receipt, and
wherein said server node comprises advertisement count requesting means for periodically requesting an advertisement count indicating how many times said advertising content has been counted for a selected POS device.

23. The system according to claim 22, wherein said server node comprises:
means for summing up advertisement counts from said selected POS device and calculating an advertising fee for the summed up advertisement counts; and
means for sending advertising fee billing information including the advertisement counts and the calculated advertising fee.

24. The system according to claim 2, wherein said server node further comprises:
means for providing a store environment form prompting entry of said store environment information for said POS device in response to access from said POS device; and
means for providing an advertisement request form and an advertising content creation form prompting entry of said advertisement request information and said advertising content for said advertiser terminal in response to access from said advertiser terminal.

25. The system according to claim 2, wherein
said POS device comprises display means for displaying said stored advertising content on a screen.

26. The system according to claim 3, wherein said POS device further comprises means for counting a number of times said advertising content has been printed on the sales receipt, and
wherein said server node comprises advertisement count requesting means for periodically requesting an advertisement count indicating how many times said advertising content has been counted for a selected POS device.

27. The system according to claim 26, wherein said server node comprises:
means for summing up advertisement counts from said selected POS device and calculating an advertising fee for the summed up advertisement counts; and
means for sending advertising fee billing information including the advertisement counts and the calculated advertising fee.

28. The system according to claim 3, wherein said server node further comprises:
means for providing a store environment form prompting entry of said store environment information for said POS device in response to access from said POS device; and
means for providing an advertisement request form and an advertising content creation form prompting entry of said advertisement request information and said advertising content for said advertiser terminal in response to access from said advertiser terminal.

29. The system according to claim 3, wherein
said POS device comprises display means for displaying said stored advertising content on a screen.

30. The method according to claim 9, further comprising the steps of:
counting a number of times said advertising content has been printed on the sales receipt, by said POS device; and
periodically requesting, by said server node, an advertisement count indicating how many times said advertising content has been counted for a selected POS device.

31. The method according to claim 28, further comprising the steps of:
summing up, by said server node, advertisement counts from said selected POS device and calculating an advertising fee for the summed up advertisement counts; and
sending, by said server node, advertising fee billing information including the summed up advertisement counts and the calculated advertising fee.

32. The method according to claim 9, further comprising:
providing, by said server node, a store environment form prompting entry of said store environment information for said POS device in response to access from said POS device; and
providing, by said server node, an advertisement request form and an advertising content creation form prompting entry of said advertisement request information and said advertising content for said advertiser terminal in response to access from said advertiser terminal.

33. The method according to claim 9, further comprising the step of:
displaying, by said POS device, said stored advertising content on a screen.

34. The method according to claim 10, further comprising the steps of:
counting a number of times said advertising content has been printed on the sales receipt, by said POS device; and
periodically requesting, by said server node, an advertisement count indicating how many times said advertising content has been counted for a selected POS device.

35. The method according to claim 34, further comprising the steps of:
summing up, by said server node, advertisement counts from said selected POS device and calculating an advertising fee for the summed up advertisement counts; and
sending, by said server node, advertising fee billing information including the summed up advertisement counts and the calculated advertising fee.

36. The method according to claim 10, further comprising:
providing, by said server node, a store environment form prompting entry of said store environment information for said POS device in response to access from said POS device; and
providing, by said server node, an advertisement request form and an advertising content creation form prompting entry of said advertisement request information and said advertising content for said advertiser terminal in response to access from said advertiser terminal.

37. The method according to claim 10, further comprising the step of:
displaying, by said POS device, said stored advertising content on a screen.

38. The computer program product according to claim 16, further comprising the steps of:
counting, by said POS device, a number of times said advertising content has been printed on the sales receipt; and
periodically requesting, by said server node computer, an advertisement count indicating how many times said advertising content has been counted for a selected POS device.

39. The computer program product according to claim 38, further comprising the steps of:
summing up, by said server node computer, advertisement counts from said selected POS device and calculating an advertising fee for the summed up advertisement counts; and
sending, by said server node computer, advertising fee billing information including the summed up advertisement counts and the calculated advertising fee.

40. The computer program product according to claim 16, further comprising the steps of:
providing, by said server node computer, a store environment form prompting entry of said store environment information for said POS device in response to access from said POS device; and
providing, by said server node computer, an advertisement request form and an advertising content creation form prompting entry of said advertisement request information and said advertising content for said advertiser terminal in response to access from said advertiser terminal.

41. The computer program product according to claim 16, further comprising:
displaying, by said POS device, said stored advertising content on a screen.

42. The computer program product according to claim 17, further comprising the steps of:
counting, by said POS device, a number of times said advertising content has been printed on the sales receipt; and
periodically requesting, by said server node computer, an advertisement count indicating how many times said advertising content has been counted for a selected POS device.

43. The computer program product according to claim 42, further comprising the steps of:
summing up, by said server node computer, advertisement counts from said selected POS device and calculating an advertising fee for the summed up advertisement counts; and
sending, by said server node computer, advertising fee billing information including the summed up advertisement counts and the calculated advertising fee.

44. The computer program product according to claim 17, further comprising the steps of:
providing, by said server node computer, a store environment form prompting entry of said store environment information for said POS device in response to access from said POS device; and
providing, by said server node computer, an advertisement request form and an advertising content creation form prompting entry of said advertisement request information and said advertising content for said advertiser terminal in response to access from said advertiser terminal.

45. The computer program product according to claim 17, further comprising:
displaying, by said POS device, said stored advertising content on a screen.

46. The system according to claim 1, wherein there is provided a store terminal in said store, said store terminal comprising means for performing network-communication with said server node and means for performing off-line or on-line communication with at least one POS device provided in said store.

47. The system according to claim 2, wherein there is provided a store terminal in said store, said store terminal comprising means for performing network-communication with said server node and means for performing off-line or on-line communication with at least one POS device provided in said store.

48. The system according to claim 3, wherein there is provided a store terminal in said store, said store terminal comprising means for performing network-communication with said server node and means for performing off-line or on-line communication with at least one POS device provided in said store.
